(19) United States
(12) Patent Application Publication
(10) Pub. No.: US 2005/0213557 A1
(43) Pub. Date: Sep. 29, 2005

(54) Multimedia communication and collaboration system and protocols

(76) Inventors: Cherng-Daw Hwang, San Jose, CA (US); Steven Wang, Cupertino, CA (US); Weiping Li, Palo Alto, CA (US)

Correspondence Address: Lester J. Vincent;BLAKELY, SOKOLOFF, TAYLOR & ZAFMAN LLP, Seventh Floor, 12400 Wilshire Boulevard, Los Angeles, CA, 90025, US

(21) Appl. No.: 10/810,791

(22) Filed: Mar. 26, 2004

(51) Int. Cl. H04L 12/56

(52) U.S. Cl. 370/351

(57) ABSTRACT

A system is described that includes a real-time routing server to route and process multimedia sessions over a network. The system also includes a group server to manage the multimedia communications sessions over the network. The group server is coupled to the routing server. The system further includes a plurality of end-point processing devices to schedule and conduct multimedia communications sessions over the network. The plurality of end-point processing devices are coupled to the routing server and the group server. Protocols determine the topology of the network, reserve bandwidth, reserve media processing resources, and find the best route and the best real-time routing server to transfer and process multimedia data.

### FIELD

Embodiments of the present invention relate to systems and protocols for multimedia communication sessions and collaboration. More particularly, embodiments of the present invention relate to systems and protocols allowing multiple users to communicate with each other in real time through delivery of high-quality video, audio, images, text, and documents through Internet Protocol (“IP”) networks.

### BACKGROUND

Multi-party and multimedia communication in real time has been a challenging technical problem for a long time. The most straightforward way is for each user to send media data (such as video, audio, images, text, and documents) to every other user, as illustrated in FIG. 1.

Such a prior art mesh connection of users typically requires very high bandwidth because each user has to receive different media data from multiple users and each user has to send the identical media data to multiple users. The total bandwidth of the data traffic in the network would increase quickly with the number of users. The required processing power of each user terminal would also increase with the number of users. Therefore, such a mesh connection of multiple users is typically disadvantageous.

The prior art video conferencing system of FIG. 2 attempts to solve this problem by using a Multipoint Control Unit (“MCU”) as a central connection point for all users.

To save bandwidth, the MCU receives encoded video bitstreams from all users, decodes them, mixes all or a selected number of video sequences into one video sequence, encodes the combined video sequence, and sends a single bitstream to each user individually. In the process of mixing multiple video sequences, the resolution of some input video sequences typically has to be reduced in order for the combined video sequence to fit into a given resolution. For example, if User 1, User 2, and User 3 use the Common Intermediate Format (“CIF”) for their video, and User 4, User 5, and User 6 use the Quarter CIF (“QCIF”) for their video, the video resolution of the first three users is 352×288 pixels and the video resolution of the last three users is 176×144 pixels. Assuming that the first four video sequences typically are mixed into a single CIF video sequence, the resolution of the first three video sequences has to be reduced from CIF to QCIF before they are combined with the fourth one into the output video sequence. FIG. 3 illustrates the process for this example. The choice of which video sequences are mixed together is typically made by either voice activated selection (“VAS”) or chair control. In the above example, if VAS is used, four video sequences associated with the loudest four voices in the video conference are selected for mixing. If chair control is used, one of the users is designated as the chair and this user can determine which video sequences are mixed together.

With a single MCU, the number of users is typically limited because both bandwidth and processing power of the MCU would increase with the number of users. To handle a large number of simultaneous video conferences with many users, in the prior art multiple MCUs are cascaded, as illustrated in FIG. 4. In a traditional video conferencing system, there typically is a Gatekeeper that, among other things, keeps information about which users are connected to which MCUs and how the MCUs are cascaded so that the video calls can be made through appropriate MCUs between users. For each MCU, the connection to another MCU is typically treated the same as the connection to a user. For example, if a video conference involves the three users on MCU 1, two of the users on MCU 2, two of the users on MCU 3, and three of the users on MCU 4, each individual MCU mixes its own local video and sends the mixed video to its neighbor MCU as a single video bitstream. This means that the video from User 1.1 is sent to User 4.1 through three video mixers on MCU 1, MCU 3, and MCU 4.

One of the problems in such a prior art cascaded MCU video conferencing system is the end-to-end delay, especially on an IP network. First, video processing on each MCU introduces a delay. Second, each MCU typically has to wait for all relevant video packets to arrive before decoding and mixing multiple video sequences. There is also transmission delay. The total end-to-end delay can therefore sometimes be too long for users to have real-time interactive communication. The amount of delay typically increases with the number of cascaded MCUs in the delivery path between any two end-points.

Therefore, one disadvantage of a traditional prior art video conferencing system is the inability to handle many users. Another disadvantage of a traditional prior art video conferencing system is that typically the cost per user is relatively high. Another disadvantage is that the complexity of call setup typically can become very high very quickly when the number of users and cascaded MCUs increases.

### SUMMARY

A system is described that includes a real-time routing server to route and process multimedia sessions over a network. The system also includes a group server to manage the multimedia communications sessions over the network. The group server is coupled to the routing server. The system further includes a plurality of end-point processing devices to schedule and conduct multimedia communications sessions over the network. The plurality of end-point processing devices are coupled to the routing server and the group server.

A method is described for determining a topology of a network. Respective addresses for real-time routing servers to route and process multimedia communication sessions over the network are obtained from a group server. A static neighbor configuration is set. A dynamic neighbor configuration is determined based on quality of service levels for respective paths between real-time routing servers, hop counts along paths, delays between real-time routing servers, bandwidth capacity between real-time routing servers, and common path traffic between real-time routing servers.

A method is described for reserving bandwidth and media processing resources. A check is made whether media processing resources on a source real-time routing server are sufficient for a user to join a multimedia communication session. For a multimedia communication session involving multiple real-time routing servers, reservation requests are sent from the source real-time routing server to all destination real-time routing servers. A check is made for notification of successful bandwidth reservations for paths from the source real-time routing server to destination real-time routing servers. A check is made for notifications of successful media processing resource reservations for destination real-time routing servers.

A method is described for reserving bandwidth in a network. At a first real-time routing server, a bandwidth reservation request is received from an upstream real-time routing server. A determination is made whether at least one downstream path to a destination real-time routing server has enough bandwidth. If the first real-time routing server is a transit real-time routing server and not a destination real-time routing server, then the bandwidth reservation request is forwarded to a downstream neighbor real-time routing server that has enough bandwidth and a usage count is left unchanged. If the first real-time routing server is a destination only real-time routing server or a destination and transit real-time routing server, then bandwidth is reserved for a path between the first real-time routing server and the upstream neighbor real-time routing server. If the first real-time routing server is not only a transit real-time routing server, but also a destination real-time routing server, then the bandwidth reservation request is forwarded to a downstream neighbor real-time routing server that has enough bandwidth, and the usage count is incremented by one.

Other features and advantages of the present invention will be apparent from the accompanying drawings and from the detailed description that follows.

### BRIEF DESCRIPTION OF THE DRAWINGS

Embodiments of the present invention are illustrated by way of example and not limitation in the accompanying drawings, in which like references indicate similar elements, and in which:

FIG. 1 shows a prior art mesh network;

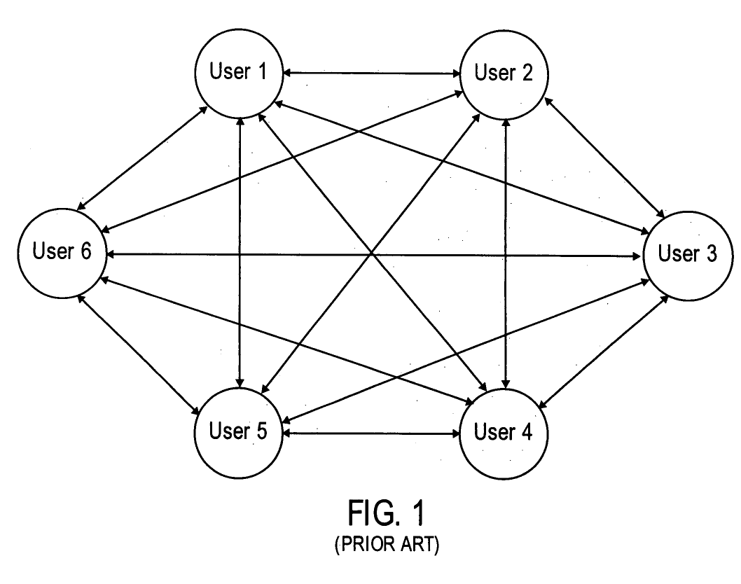

FIG. 2 illustrates a prior art video conferencing system with a single multipoint control unit;

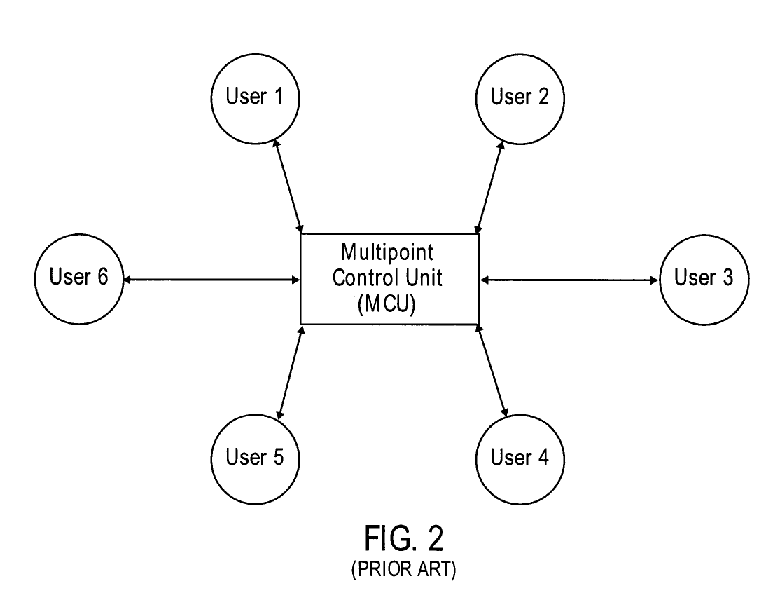

FIG. 3 shows a prior art example of mixing four video sequences into one in a multipoint control unit;

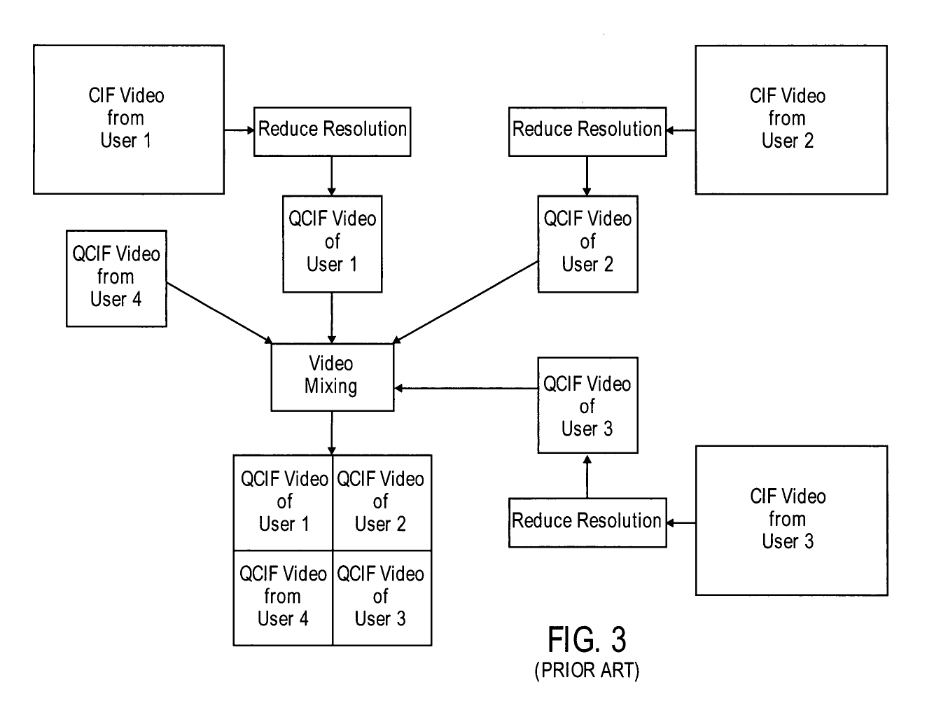

FIG. 4 shows cascaded multipoint control units in a prior art video conferencing system;

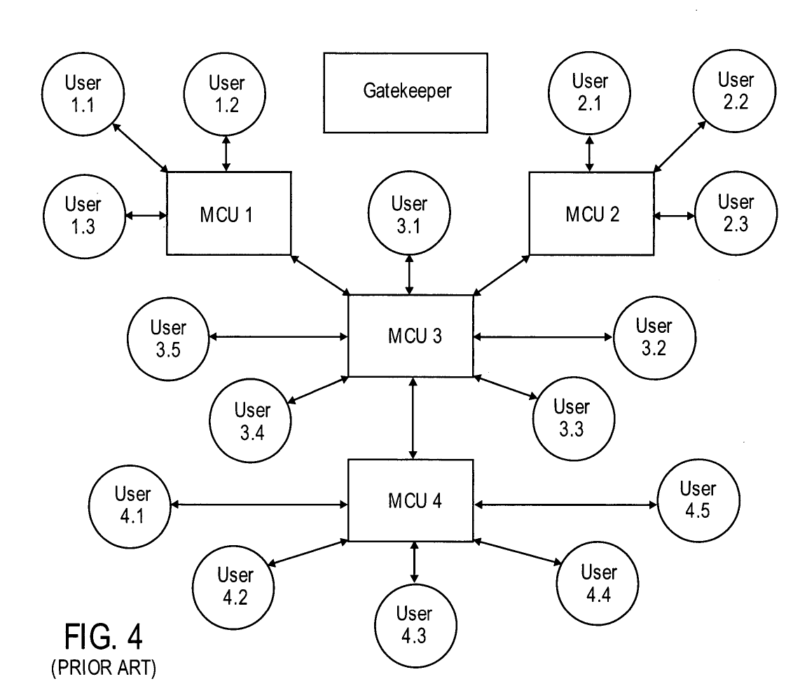

FIG. 5 shows an embodiment of a system including a group server, multimedia application routing servers, and end-point devices;

FIG. 6 is a block diagram of a multimedia application routing server;

FIG. 7 is a block diagram of system control module of a multimedia application routing server;

FIG. 8 is a block diagram of a media functional module of a multimedia application routing server;

FIG. 9 is a flow chart of an automatic topology protocol (“ATP”);

FIG. 10 is a flow chart of a method for finding dynamic neighbor multimedia application routing servers as part of the automatic topology protocol;

FIG. 11 is a flow chart of call admission control, the reservation of bandwidth, and the reservation of media processing resources for a new user as part of an advanced service routing protocol (“ASRP”).

FIG. 12 is a flow chart of a method of reserving bandwidth and call admission control as part of an advanced service routing protocol;

FIG. 13 shows a video processing scheme involving at most two multimedia application routing servers.

FIG. 14 shows an alternative way of processing video involving multimedia application routing servers.

### DETAILED DESCRIPTION

Embodiments of the invention help to overcome problems with typical prior art video conferencing systems and add functionality for real-time multimedia communication and collaboration. A component of a system architecture of an embodiment of the invention is the Multimedia Application Routing Server (“MARS”) that is capable of both routing and processing multimedia data. The MARS unit is also referred to as a real-time routing server. Other components of the system include an end point (“EP”) and a group server (“GS”). The end point is also referred to as an end-point processing device.

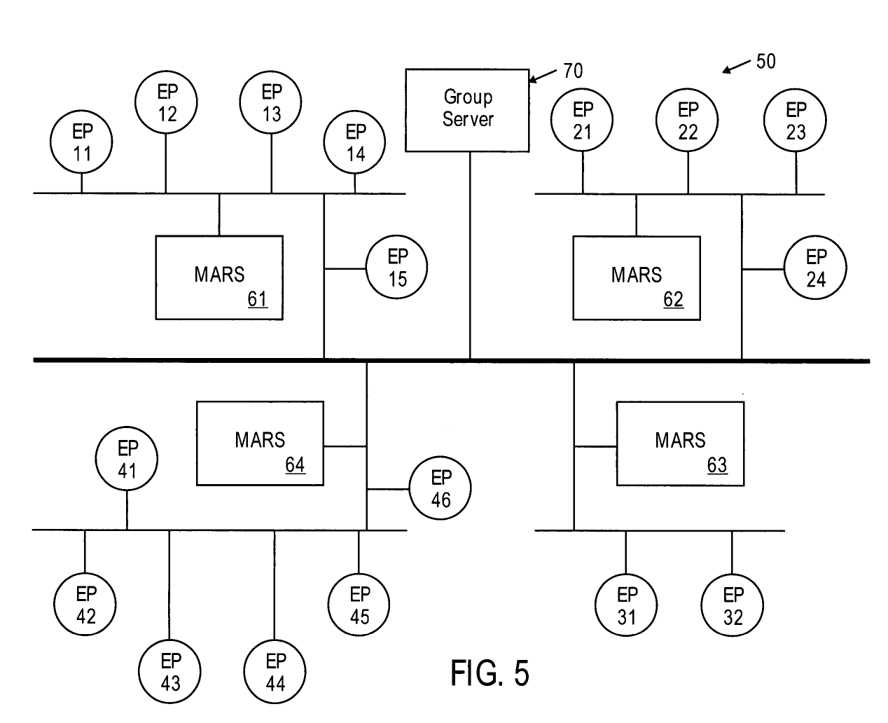

FIG. 5 shows system 50 that provides real-time multimedia communication and collaboration. System 50 is an example of a system having four MARS units 61-64. The real-time routing servers 61-64 are coupled via a network to group server 70. The MARS units 61-64 and group server 70 are also coupled via a network to end-point processing devices 11-15, 21-24, 31-32, and 41-46. All components of system 50—the MARS units 61-64, the group server 70, and EP devices 11-15, 21-24, 31-32, and 41-46—are coupled to an Internet Protocol (“IP”) network and are identified by their IP address. Alternatively, other types of networks and other types of addressing are used.

For other embodiments, more or fewer MARS devices, group servers, and EP devices can be part of multimedia communication and collaboration system 50. For example, there could be one MARS device, one group server, and several EP devices. As another example, there could be 10 MARS units, one group server, and 45 EP processing devices.

Users of system 50 interact with end point processing devices 11-15, 21-24, 31-32, and 41-46. System 50 allows the users of the end-point processing devices to send video in real time with minimal delay. The users can therefore communicate and collaborate. In addition to real-time video, system 50 also allows the users to send real-time audio with minimal delay. System 50 also allows the users to send other digital information, such as images, text, and documents. Users can thus establish real-time multimedia communication sessions with each other using system 50.

Each user of system 50 is registered into the group server database and identified by a user email address. To conduct a session, a user is associated with an end point, an end point is associated with a MARS, and a MARS is associated with a group server.

The group server 70 manages multimedia communications sessions over the network of system 50. In the group server 70, several software processes are running to manage all communication sessions within its group of users and to exchange information with other group servers for conducting sessions across groups. For one embodiment, the group server 70 uses the Linux operating system. The software processes running in the group server 70 include a provisioning server, a web server, and processes relating to multimedia collaboration and calendar management.

The functionality of a MARS device can be divided into two broad categories. One is to route media data and the other is to process media data. Unlike certain prior art cascading MCUs in a traditional prior art video conferencing system where static data paths are typically determined at the time of setting up the system, MARS dynamically finds the best route with enough bandwidth to deliver media data from source to destination with the shortest delay. Also unlike certain prior art cascading MCUs in a traditional prior art video conferencing system where video may be processed in every MCU along a path from source to destination, the architecture of system 50 guarantees that video processing is performed at most in two MARS units from a video source to any given destination.

The technique for finding the best media route includes two protocols specifically defined for this purpose. One is the Automatic Topology Protocol (“ATP”) and the other is the Advanced Service Routing Protocol (“ASRP”). ATP is used to communicate the system topology among the MARS units so that every MARS is aware of its neighbors and the connection bandwidth with its neighbors. ATP is used whenever there is a new MARS on the network or there is a change in the system configuration. ASRP enables every MARS to use the ATP information and to dynamically probe its neighbors for data traffic delay so that the shortest delay path is determined for the media packets to be sent from the MARS units to their destinations.

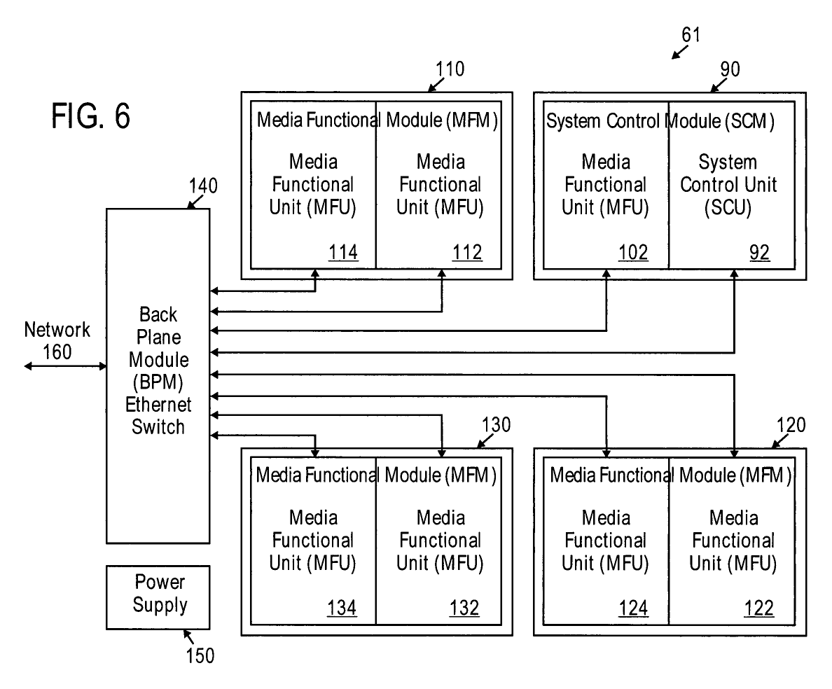

FIG. 6 is block diagram of multimedia application routing server 61, also referred to as real-time routing server 61. The MARS unit 61 includes a system control module 90 (“SCM”) and media functional modules (“MFMs”) 110, 120, and 130. Media functional modules 110, 120, and 130 are also referred to as multi-function modules. The system control module 90 and the media functional modules 110, 120, and 130 are coupled to backplane module (“BPM”) ethernet switch 140. Alternatively, another type of switch can be used.

For one embodiment of the invention, BPM Ethernet switch 140 is a model BCM 5646 Ethernet switch supplied by Broadcom Corporation of Irvine, Calif. Power supply 150 is coupled to Ethernet switch 140 and the other components. Backplane module Ethernet switch 140 is in turn coupled to internet protocol network 160.

The system control module 90 includes system control unit (SCU) 92 and media functional unit (MFU) 102. Media functional module 110 includes media functional units 112 and 114. Media functional module 120 includes media functional units 122 and 124. Media functional module 130 includes media functional units 132 and 134. Media functional units 102, 112, 114, 122, 124, 137, and 134 are also referred to as multifunction units.

The architecture of MARS 61 provides high speed multimedia and video processing. For one embodiment of the invention, MARS 61 has a benchmark speed of approximately 120,000 million instructions per second (MIPS). MARS unit 61 acts as both a router and a server for a network. The architecture of MARS 61 is geared towards high speed real time video and multimedia processing rather than large storage. The MARS unit 61 thus allows for real-time video communication and collaboration sessions.

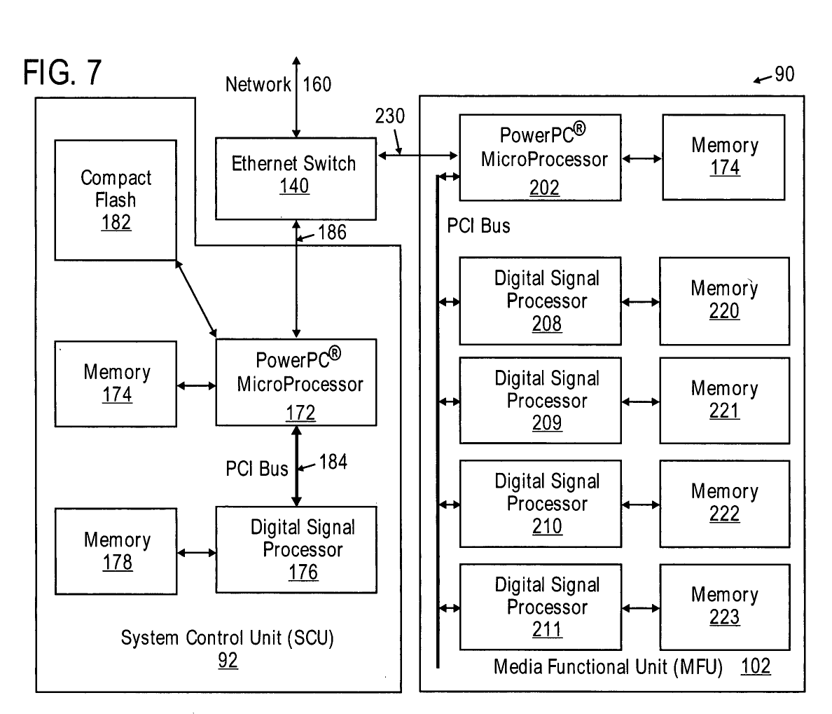

FIG. 7 is a block diagram of system control module 90, which includes system control unit 92 and media functional unit 102. System control unit 92 controls the real-time routing server 61. System control unit 92 includes a PowerPC® microprocessor 172 supplied by Motorola Corporation of Schaumburg, Ill. The PowerPC microprocessor 172 is coupled to a compact flash card 182. The compact flash card contains the Linux operating system for the microprocessor 172. The compact flash card 182 acts in a way analogous to a hard disk drive in a personal computer. Microprocessor 172 is also coupled to synchronous DRAM (“SDRAM”) memory 174. Memory 174 holds code and data for execution by microprocessor 172. For one embodiment of the invention, memory 174 is 32 megabytes in size. For alternative embodiments, memory 174 can be smaller or larger than 32 megabytes.

PowerPC microprocessor 172 is coupled to digital signal processor (“DSP”) 176 via PCI bus 184. For one embodiment, DSP 176 is a model TMS 320C6415 DSP supplied by Texas Instruments Inc. of Dallas, Tex. DSP 176 is a media processing resource for system control unit 92. Digital signal processor 176 is coupled to a 32 megabytes SDRAM memory 178. Alternative embodiments have a memory 178 that is larger or smaller.

PowerPC microprocessor 172 is coupled to Ethernet switch 140 via lines 186. Ethernet switch 140 is in turn coupled to network 160. Media functional unit 102 includes a Power PC® microprocessor 202 that is coupled to a 32 megabytes SDRAM memory 204.

PowerPC microprocessor 202 is coupled to PCI bus 206. PCI bus 206 is in turn coupled to digital signal processors 208 thru 211. Each digital signal processors 208 thru 211 is a model TMS320C6415 DSP supplied by Texas Instruments Inc. of Dallas, Tex. Digital signal processor 208 is coupled to SDRAM memory 220. Digital signal processor 209 is coupled to SDRAM memory 221. Digital signal processor 210 is coupled to SDRAM memory 222. Digital signal processor 211 is coupled to SDRAM memory 223. For one embodiment, each of SDRAM memories 220 thru 223 comprises a 32 megabyte memory.

PowerPC microprocessor 202 is also coupled to Ethernet switch 140 via lines 230.

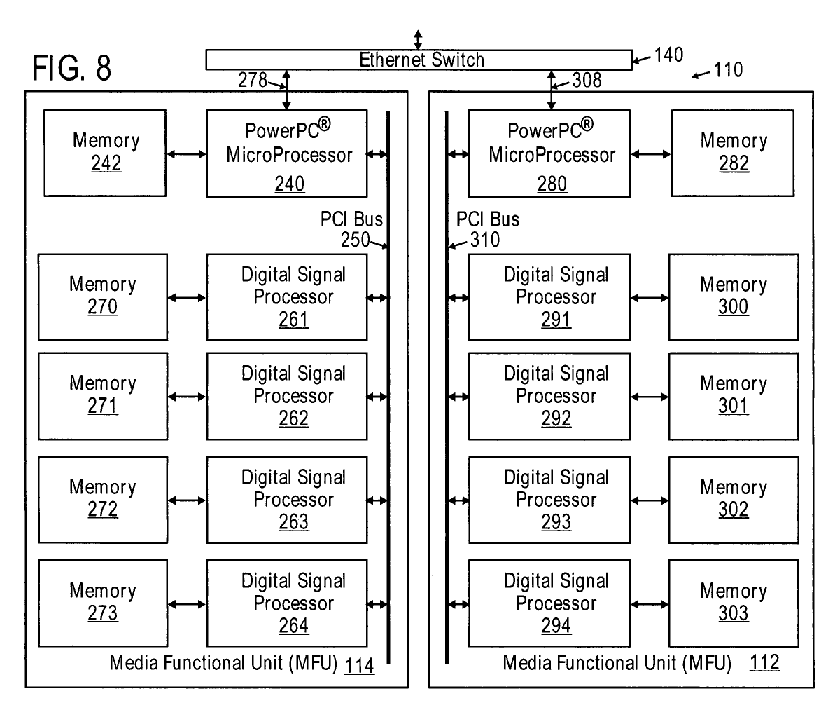

FIG. 8 includes a block diagram of media functional module 110, which includes media functional units 112 and 114. Media functional unit 112 includes a PowerPC microprocessor 280 that is coupled to 32 megabytes of SDRAM memory 282. PowerPC microprocessor is coupled to PCI bus 310. The PowerPC microprocessor is also coupled to Ethernet switch 140 via lines 308.

PC bus 310 is in turn coupled to digital signal processors 291 thru 294. Digital signal processor 291 is coupled to 32 megabytes SDRAM memory 300. Digital signal processor 292 is coupled to 32 megabytes SDRAM memory 301. Digital signal processor 293 is coupled to 32 megabytes SDRAM memory 302. Digital signal processor 294 is coupled to 32 megabytes SDRAM memory 303.

Media functional unit 114 is similar to media functional unit 112. Media functional unit 114 includes a PowerPC microprocessor 240 coupled to SDRAM memory 242. The PowerPC microprocessor 240 is coupled to Ethernet switch 140 via lines 278. The PowerPC microprocessor 240 is also coupled to PCI bus 250.

PCI bus 250 is turn coupled to digital signal processors 261 thru 264. Digital signal processor 261 is coupled to memory 270. Digital signal processor 262 is coupled to memory 271. Digital signal processor 263 is coupled to memory 272. Digital signal processor 264 is coupled to memory 273. Each of memories 270 thru 273 is a 32 megabytes SDRAM memory. For alternative embodiments, other sizes of memory can be used.

The media functional modules 120 and 130 shown in FIG. 6 are similar to media functional module 110.

MARS 61 can route media data and process media data. The digital signal processors of MARS 61, such as digital signal processors 261 thru 264, act as digital media processing resources. The system control unit 92 of MARS 61 is used to route media data.

The technique for finding the best media route includes two protocols specifically defined for this purpose. The programs for executing protocols are stored in the compact flash memory 182 of system control unit 92 and are executed by the microprocessor 72. One of the protocols is the automatic topology protocol (“ATP”). The other protocol is the advanced service routing protocol (“ASRP”).

The ATP protocol is used to communicate the system 50 topology among the MARS units 61 thru 64 so that every MARS unit is aware of its neighbors and has a routing table for sending media packets to any destination MARS unit through the neighbors of the MARS unit. The ATP protocol is used periodically to check the system 50 topology in case that there is a new MARS on the network or there is a change in the system 50 configuration.

The ASRP protocol enables every MARS unit to use the ATP information and to dynamically communicate with the neighbors of the MARS unit for resource reservation. The ASRP protocol is also used to find the best route for media packets to be sent from any MARS unit to the destinations of the media packets.

The ATP and ASRP protocols are thus used in setting up and conducting multimedia communication and collaboration sessions.

The microprocessor 172 in the system control unit 92 of the MARS unit 61 is used to run the ATP and ASRP protocols. The digital signal processors in the system control unit 92 and the media functional units 102, 112, 114, 122, 124, 132, and 134 are used to run media processing tasks.

The ATP protocol uses several mechanisms for a MARS unit to find the neighbor MARS units. The definition of a neighbor involves several attributes. Those attributes can include the quality of service (“QoS”) level along a path from one MARS unit to another, the number of IP routers (hops) along the path, the delay between two MARS units, the bandwidth capacity between two MARS units, the utilization traffic between two MARS units, and any administration policies.

If a source MARS unit and destination MARS unit are not neighbors of each other, then the media traffic from the source MARS unit is sent to its neighbor MARS unit that is one step closer to the destination MARS unit. The neighbor MARS unit forwards the traffic to the destination MARS unit, perhaps through another neighbor MARS unit.

Some of the attributes that define the network topology of system 50 are detected automatically. For example, the IP route information and policy-based constraints are detected through several standard routing protocols. Those standard routing protocols can include the Open Shortest Path First (“OSPF”) routing protocol, the Border Gateway Protocol (“BGP”), the Routing Information Protocol (“RIP”), and the Internet Control Message Protocol (“ICMP”) to query route information from routers; the Resource reSerVation Protocol with Traffic Engineering (“RSVP-TE”) or other standard Multi Protocol Label Switching (“MPLS”) network protocols to request the explicit route with Service Level Agreement (“SLA”) in an MPLS environment; and the Optical Internetworking Forum's User-Network Inferface (“OIF-UNI”) protocol to request the explicit path with SLA for optical networks.

If a MARS unit is to be used in any other networks, such as the emerging Ethernet in the First Mile (“EFM”) network or an L2 Ethernet-based Virtual Private Network (“VPN”) in a metro Ethernet infrastructure, than different protocols are used to request explicit route with SLA in those networks.

To measure the delay between any two MARS units, the Network Time Protocol (“NTP”) can be used to synchronize the local times between the two MARS units and a set of time-stamped packets can be sent between the two MARS units for measurements.

To measure the bandwidth capacity between any two MARS units, packet dispersion techniques can be used.

The final result of running the ATP protocol is a routing table on each MARS unit that contains neighbor information. A timer can be used to trigger ATP operations periodically to see if there are changes in the system 50 configuration. In the routing table, multiple paths from one MARS unit to another MARS unit are allowed and the real routing path is determined dynamically.

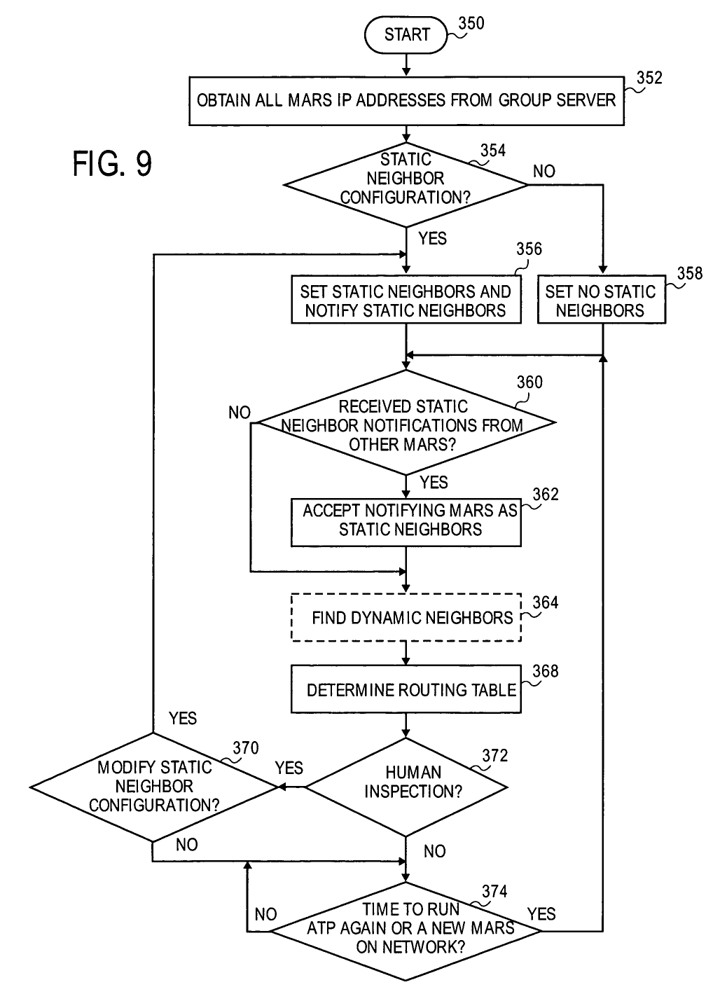

FIG. 9 is a flow chart of the ATP protocol operations. The ATP protocol starts at operation 350. At operation 352, the IP addresses of all the MARS units within system 50 are obtained from the group server 70.

Operation 354 checks whether a static neighbor configuration is to be used. A static neighbor configuration is a configuration set by a network administrator manually that sets forth the neighborhood of MARS units. If a static neighbor configuration is not to be used, than at operation 358 no static neighbors are set.

If the static neighborhood configuration is to be set, then at operation 356 the static MARS neighbors are set and the static MARS neighbors are notified.

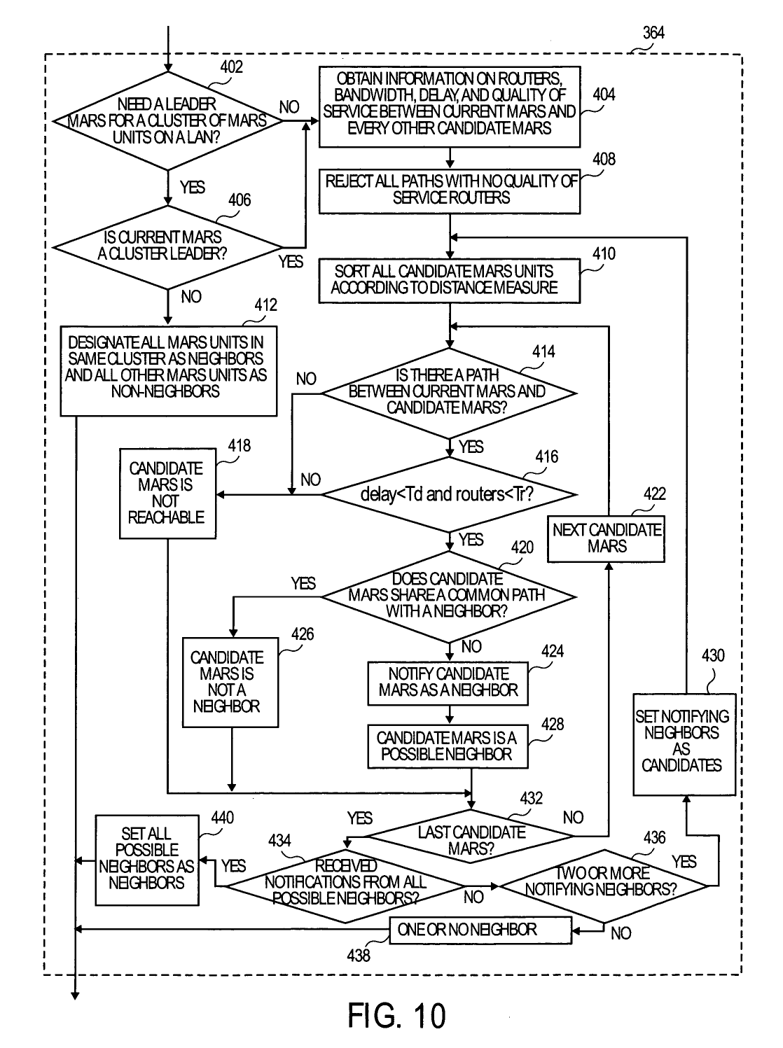

Operation 360 is a check to see if static MARS neighbor notifications have been received from other MARS units. If no, then process flow proceeds to operation 364, which is finding the dynamic MARS neighbors. If, however, the MARS unit has received static neighbor notification from other MARS units, then process proceeds to operation 362. Operation 362 is accepting notifying MARS units as static neighbors. The next operation after operation 362 is operation 364, which is finding dynamic MARS unit neighbors. The operation 364 for finding dynamic neighbors is described in more detail below in connection with FIG. 10.

As shown in FIG. 9, the next operation after operation 364 is operation 368 for determining the routing table. The next operation is operation 372, which is an inquiry as to whether human inspection is used with respect to the network configuration. If human inspection is to be used, then flow proceeds to operation 370, which is a check as to whether the static neighbor configuration is to be modified. If the static neighbor configuration is to be modified, then flow proceeds back to operation 356, which is setting static neighbors and notifying static neighbors. If the static neighbor configuration is not to be modified, then flow proceeds to operation 374. If at operation 372 there is to be no human inspection, then flow proceeds to operation 374.

Operation 374 asks whether it is time to run the ATP protocol again or whether a new MARS unit has been added to the network. If it is time to run the ATP again or a new MARS unit has been added to the system or network, then flow proceeds to operation 360, which is a check to see if static neighbor notifications have been received from other MARS units. If it is not time to run the ATP protocol again or a new MARS unit has not been added to the network, then operation 374 is then repeated at a later time, possibly set by a timer.

FIG. 10 is a flow chart of the process 364 for finding dynamic neighbors as part of the ATP protocol. Process 364 begins at operation 402 for checking whether a leader MARS unit is needed for a cluster of MARS units on a local area network. If a leader MARS unit is not needed, then flow proceeds to operation 404. At operation 404 information is obtained on the routers, the bandwidth, the delay, and the quality of service between current MARS units and every other candidate MARS units.

If operation 402 determines that a leader MARS unit is needed for a cluster of MARS units on a LAN, then process flow proceeds to operation 406, where a check is made as to whether the current MARS unit is a cluster leader. If the current MARS unit is a cluster leader, then process flow proceeds to operation 404. If at operation 406 it is determined that the current MARS unit is not a cluster leader, then process flow proceeds to operation 412. At operation 412, all MARS units in the same cluster are designated as neighbors and all other MARS units are designated as non-neighbors. After operation 412, process flow proceeds to operation 362 of FIG. 9 for determining a routing table.

As shown in FIG. 10, after the completion of operation 404, process flow proceeds to operation 408 where all paths are rejected that do not have proper quality of service routers.

Process flow continues to operation 410, where all candidate MARS units are sorted according to a distance measure.

Process flow continues to operation 414, where a check is made as to whether there is a path between the current MARS unit and the candidate MARS unit. If the answer is no, then process flow proceeds to operation 418, which indicates that the candidate MARS unit is not reachable. After operation 418, process flow continues to operation 432, which is described below.

If at operation 414 it is determined that there is a path between the current MARS unit and the candidate MARS unit, then process flow continues to operation 416. At operation 416, a check is made as to whether the delay time for the path is less than a maximum delay time (“Td”). A check at operation 416 is also made as to whether the number of IP routers along the path is less than a maximum number of IP routers (“Tr”). In other words, a check is made as to whether the number of hops along the path is less than a maximum number of hops. If at operation 416 the delay and the hop count are less than the respective maximums, then process flow proceeds to operation 420. If, however, the delay or the hop count exceeds the respective maximum, then process flow proceeds to operation 418, wherein the candidate MARS unit is labeled as not being reachable.

At operation 420, a determination is made whether the candidate MARS unit shares a common path with a neighbor MARS unit. In other words, operation 420 checks the utilization traffic between the candidate MARS unit and a neighbor MARS unit. If the answer is no, then process flow proceeds to operation 424. If the answer if yes, then process flow proceeds to operation 426.

At operation 426, the candidate MARS unit is labeled as not being a neighbor unit. From operation 426, process flow proceeds to operation 432, described below.

At operation 424, the candidate MARS unit is notified as a neighbor. Process flow moves to operation 428, wherein the candidate MARS unit is labeled as a possible neighbor.

The next operation is operation 432, wherein a check is made as to whether the candidate MARS unit is the last candidate MARS unit. If the candidate MARS unit is not the last candidate MARS unit, then process flow goes to operation 414 for the next candidate MARS unit, as indicated by operation 422.

If the MARS candidate is the last candidate MARS, then flow proceeds to operation 434. At operation 434, a check is made as to whether notifications or acknowledgements have been received from all possible neighbors. If the answer is yes, then at operation 440 all possible neighbors are set as neighbors. If the answer is no, then at operation 436 an inquiry is made as to whether there are two or more notifying neighbors. If there are two or more notifying neighbors, then at operation 430 the notifying neighbors are set as candidates and process flow proceeds to operation 410. If, however, there are not two or more notifying neighbors at operation 436, then process flow moves to operation 438, which states that there is one or no neighbor, and then process flow moves to operation 368 of FIG. 9 for determining the routing table.

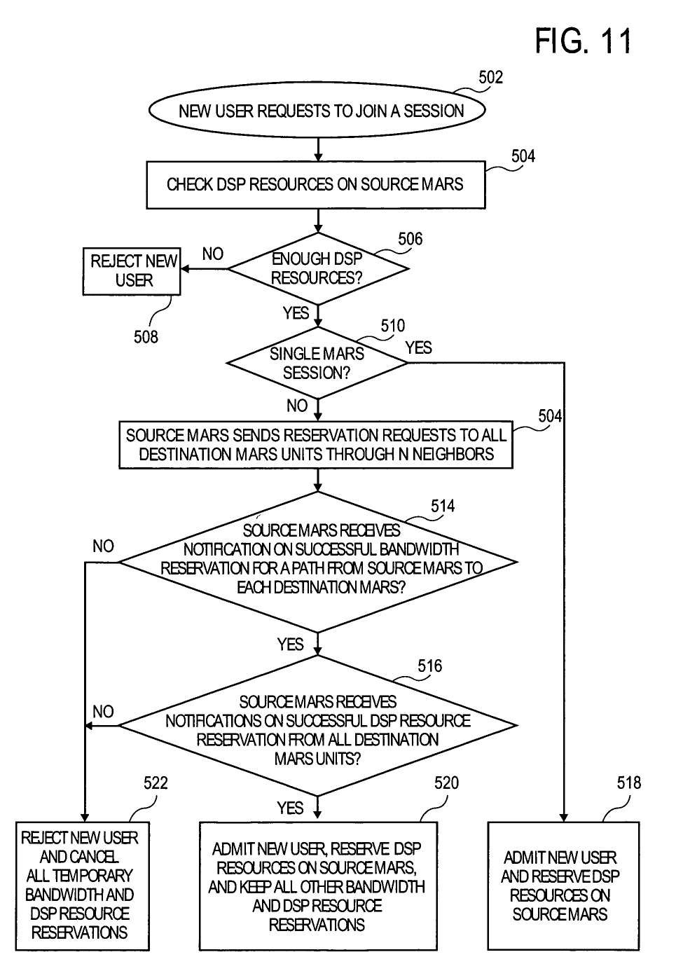

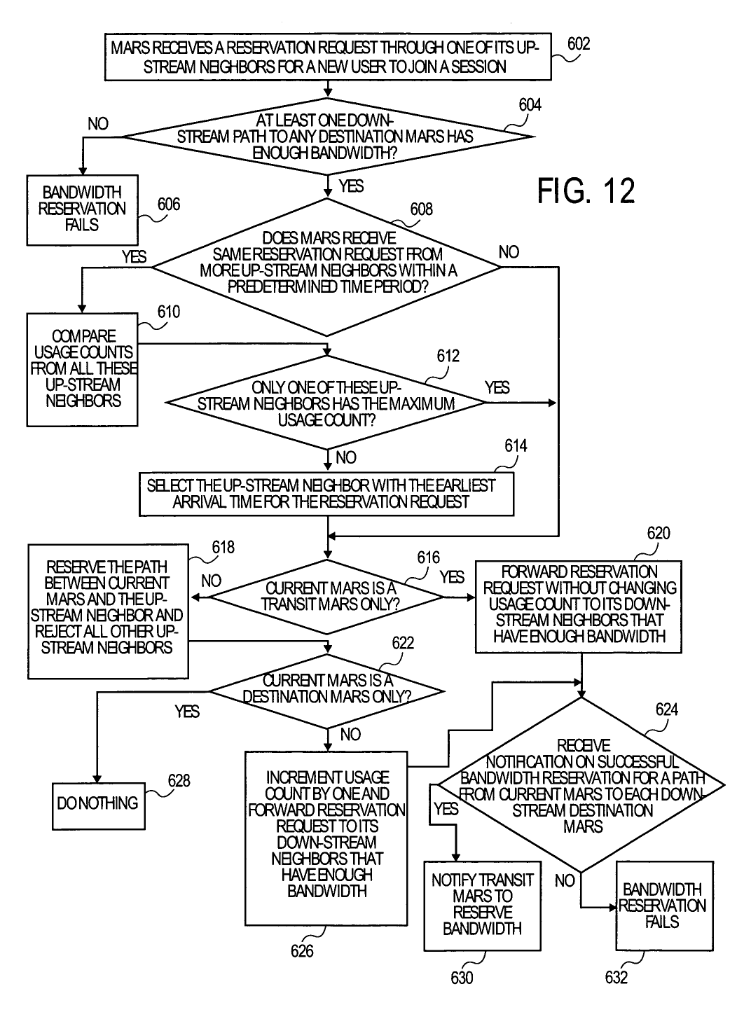

FIGS. 11 and 12 show advanced service routing protocols. Once the network topology is known, media traffic routing is performed according to a set of criteria for the best path. The ASRP protocol is used for two purposes. The first one is to find bandwidth and media processing resources for call admission control (“CAC”) and to reserve resources for admitted users. A CAC mechanism is used to ensure that all admitted communication sessions and users will have enough resources. Communication sessions or users are rejected that cannot be successfully conducted or handled.

FIG. 11 is a flow chart showing the operations of the ASRP for a CAC. Each MARS unit keeps a database for each communication session on all the registered communication session participants. The information in the database for each end point includes connection bandwidth, computing power, display capability, IP address, login user name, and ID (email address), video display layout, list of bitstreams, etc. The database on the intermediate MARS unit does not keep information on the end points that are not associated with that MARS unit. Based on such information, a MARS unit can determine what kind of operations it needs to perform on which users. Therefore, the MARS unit can provide information on how many resources are needed for any user to join a session.

FIG. 11 is thus a flow chart of a call admission control procedure that is part of the advanced service routing protocol. FIG. 11 shows a flow chart for reserving bandwidth and media processing resources for users that are admitted. The flow chart of FIG. 11 shows that new users will be rejected if sufficient bandwidth and media processing resources are not available.

At operation 502, a new user requests to join a communication session on system 50. At operation 504, a check is made as to the digital signal processing resources on the source MARS unit. Process flow then moves to operation 506, where a check is made as to whether the DSP resources are enough or sufficient. If the answer is no, then at operation 508 the new user is rejected. If the answer is yes, then process flow proceeds to operation 510.

At operation 510, a check is made as to whether the MARS session is a single MARS session. If the answer is yes, then process flow moves to operation 518. At operation 518, the new user is admitted and DSP resources are reserved on the source MARS unit. If the answer is no at operation 510, then process flow proceeds to operation 512.

At operation 512, the source MARS unit sends reservation requests to all destination MARS units through N neighbors wherein N is an integer.

Process flow then moves to operation 514. At operation 514, a check is made as to whether the source MARS unit receives notification on successful bandwidth reservation for a path from the source MARS to each destination MARS unit. If the answer is yes, then process flow moves to operation 516. If the answer is no, then process flow moves to operation 522. At operation 522, the new user is rejected. In addition, at operation 522 all temporary bandwidth and DSP resource reservations are canceled.

At operation 516, a check is made as to whether the source MARS unit receives notifications on successful DSP resource reservations from all destination MARS units. If the answer is no, then process flow moves to operation 522, wherein the new user is rejected and all temporary bandwidth and DSP resource reservations are canceled. If the answer is yes, then the new user is admitted at operation 520. At operation 520, the DSP resources on the source MARS unit are reserved. In addition, at operation 520 all other bandwidth and DSP resource reservations are kept.

Timers are used in any of the decisions that rely on receiving a notification or acknowledgement from any other devices on the network. If the expected notification or acknowledgement is not received within a preset time, the notification is considered as not being received.

FIG. 12 shows the details of a how a MARS unit determines the success or failure of a bandwidth reservation. Thus, FIG. 12 relates to the second purpose of the ASRP protocol, which is to dynamically determine the routing path for each transmission from a source to a destination. The call admission control procedure reserves bandwidth and DSP resources for a new user to join a session. Nevertheless, not every user in a communication session is actively sending media data to other users in the same session. Therefore, the ASRP procedure of FIG. 12 is used to signal the routing path for the media data from each active user. Thus the flow chart of FIG. 12 relates to call admission control, but also to reserving bandwidth in the network for the media data.

As shown in FIG. 12, at operation 602 a MARS unit receives a reservation request through one of the upstream neighbors of the MARS unit for a new user to join a communication session. Process flow proceeds to operation 604. At operation 604, a check is made to see that at least one downstream path to any destination MARS unit has enough bandwidth. If the answer is no, then at operation 606 the bandwidth reservation fails. If the answer is yes, then the process flow moves to operation 608.

At operation 608, a check is made as to whether a MARS unit receives the same reservation request from more upstream neighbors within a predetermined time period. If the answer is no, then process flow moves to operation 616, which is described below. If the answer is yes, then process flow moves to operation 610. At operation 610, a comparison of usage counts from all these upstream neighbors is made. A usage count is associated with each of the MARS units.

Process flow moves from operation 610 to operation 612. At operation 612, a check is made as to whether only one of these upstream neighbors has a maximum usage count. If the answer is yes, then process flow moves to operation 616. If the answer is no, then process flow moves to operation 614.

At operation 614, a selection is made of the upstream neighbor with the earliest arrival time for the reservation request. Process flow then moves to operation 616.

At operation 616 a check is made as to whether the current MARS unit is a transit only MARS unit. A transit only MARS unit is a MARS unit that merely transfers the media data without processing the media data (i.e., a bypass). This contrasts with a general transit MARS that forwards media data and may or may not process media data. If the current MARS unit is a transit only MARS unit, then process flow moves to operation 620. At operation 620, the reservation request is forwarded to the MARS unit downstream neighbors that have enough bandwidth. In addition, the usage count of the current MARS unit is not changed.

If the current MARS unit is not a transit only MARS unit, then process flow moves from operation 616 to operation 618. At operation 618, a path is reserved between the current MARS unit and the upstream neighbor and all other upstream neighbors are rejected.

After operation 618, process flow moves to operation 622. At operation 622, a check is made as to whether MARS unit is a destination MARS unit only. If the answer is yes, then at step 628 nothing further is done. If the answer is no, however, then process flow moves to operation 626. At operation 626, the usage count of the MARS unit is incremented by one. Furthermore, the reservation request is forwarded to its downstream neighbors that have enough bandwidth. Process flow then moves to operation 624.

After operations 626 and 620, process flow moves to operation 624. At operation 624, a check is made as to whether notification has been received on the successful bandwidth reservation for a path from the current MARS unit to each downstream destination MARS unit. If the answer is yes, then process flow moves to operation 630. At operation 630, the transit MARS unit is notified to reserve bandwidth. If the answer is no, however, then process flow moves to operation 632. At operation 632, the bandwidth reservation fails.

For a multimedia communication session, any participant is a destination. The MARS unit associated with a participant will be a destination MARS unit. An active participant in the communication session that sends data will be a source. The MARS unit associated with the active participant will be a source MARS unit. The associations between users and MARS units are determined by the group server 70 and passed to the respective MARS units. For each multimedia communication session, there is one MARS unit that monitors the communications session and determines which users are sources. In this MARS unit, the active participant can be determined automatically or be designated by a user.

Only the source and destination MARS units will process the media data, but only if data processing is needed, which is determined by the MARS unit itself. For a data stream between a source MARS unit and a destination MARS unit, the transit MARS unit does not process the data. Thus, at most two MARS units process data for a data stream between a source and destination.

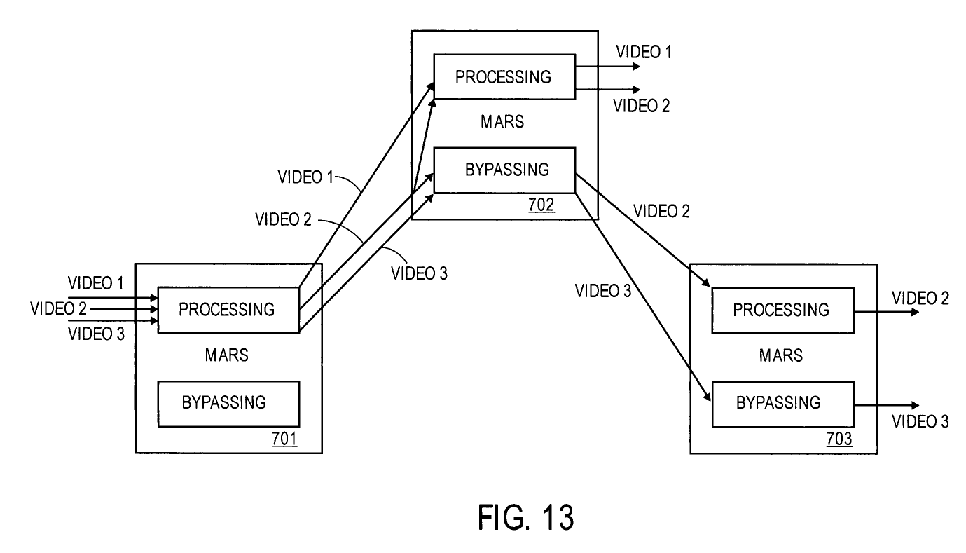

FIG. 13 is an example of how the architecture of system 50 guarantees that any video source is processed at most in two MARS units for any given destination. In this example, there are three video sources associated with MARS 701 that have to be sent to the users associated with MARS 702 and MARS 703. Assuming that all three input video sources have a high bit rate, MARS 701 performs transrating processing for all three input video bitstreams to lower the bitrate. Because video 1 is needed by the users on MARS 702 only, video 1 is sent to MARS 702 for the second processing. On the other hand, video 2 is needed by the users on both MARS 702 and MARS 703. Therefore, the video 2 bitstream is sent to MARS 702 for the second processing to satisfy the users associated with MARS 702. At the same time, the video 2 bitstream is also bypassing MARS 702 and sent to MARS 703 for the second processing to satisfy the users associated with MARS 703. MARS 702 thus acts as a general transit MARS for passing through the video 2 bitstream. Finally, video 3 is only needed by users associated with MARS 703. The video 3 bitstream bypasses MARS 702 and is sent to MARS 703. Because the video 3 bitstream does not need further processing, MARS 703 simply bypasses (i.e., passes through) the video 3 to the user without the second processing.

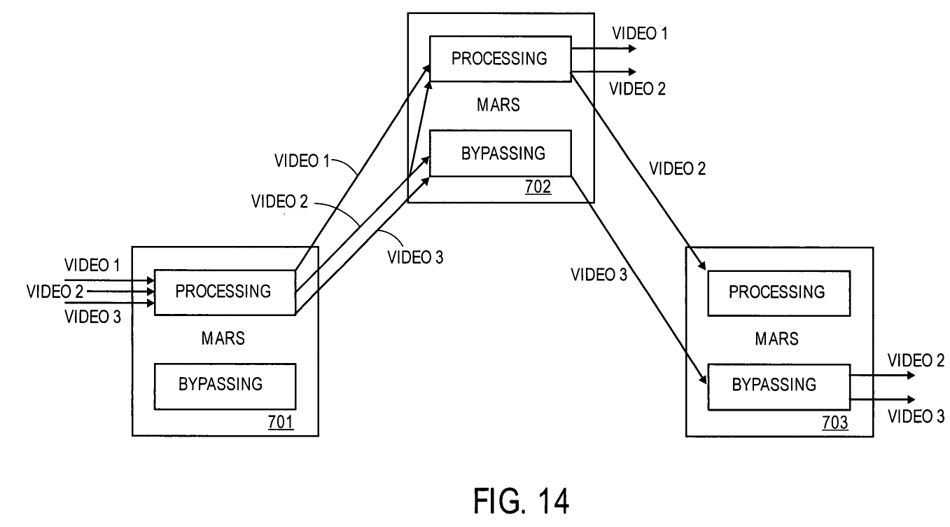

In case the required output video 2 for the users associated both MARS 702 and MARS 703 is exactly the same, an alternative way to handle the processing of video 2 is possible, as shown in FIG. 14. The difference is that the input video 2 bitstream is only sent to the processing unit in MARS 702, not the bypass (i.e., transit) routing unit. The processed video 2 bitstream is sent to MARS 703 and no further processing is needed on MARS 703. Thus MARS unit 703 acts as a transit only MARS unit. The advantage of this alternative way is to save the processing operations in MARS 703 for the identical video 2 output that is processed on MARS 702 already. The disadvantage of this alternative way is that allocation of processing resources on MARS 703 for a given video source depends on whether or not the identical output video is needed by the users associated with a transit MARS unit that happens to be another destination of the same video source.

An EP device, such as one of the EP devices 11-15, 21-24, 31-32, and 41-46 of FIG. 5, may be a personal computer (“PC”) running as a software terminal. The EP device may be a dedicated hardware device connection with user interface devices. The EP device may also be a combination of a PC and a hardware device.

An EP device is used for a human user to schedule and conduct a multimedia communication session. An EP device is capable of capturing inputs from user interface devices, such as a video camera, an audio microphone, a pointing device (such as a mouse), a typing device such as a keyboard, and any image/text display on the monitor. An EP device is also capable of sending outputs to user interface devices such as a PC monitor, a TV monitor, a speaker, and an earphone.

An EP device encodes video, audio, image, and text according to the network bandwidth and the computing power of the EP device. It sends encoded data to the MARS it is associated to. At the same time, the EP device receives coded media data from its associated MARS. The EP device decodes the data and sends decoded data to the output devices, such as the earphone or speaker for audio and the PC monitor for displaying video, image, and text. In addition to media data, an EP device also processes communication messages transmitted between the EP device and its associated MARS. The messages include scheduling a meeting, joining a meeting, inviting another user to a meeting, exiting a meeting, setting up a call, answering a call, ending a call, taking control of a meeting, arranging video positions of the meeting participants, updating buddy list status, checking the network connection with MARS, and so on.

In practice, the methods described herein may constitute one or more programs made up of machine-executable instructions. Describing the method with reference to the flow charts enables one skilled in the art to develop such programs, including such instructions to carry out the operations (acts) represented by the logical blocks on suitably configured computer or other types of processing machines (the processor of the machine executing the instructions from machine-readable media). The machine-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not limited to any particular programming language. A variety of programming languages may be used to implement embodiments of the invention. Furthermore, it is common in the art to speak of software, in one form or another (i.e., program, procedure, process, application, module, logic, etc.), as taking an action or causing a result. Such expressions are merely a shorthand way of saying that execution of the software by a machine caused the processor of the machine to perform an action or produce a result. More or fewer processes may be incorporated into the methods illustrated without departing from the scope of the invention and that no particular order is implied by the arrangement of blocks shown and described herein.

Embodiments of the invention have been described. It will, however, be evident that various modifications and changes may be made thereto without departing from the broader spirit and scope of the invention. The specification and drawings are, accordingly, to be regarded in an illustrative rather than a restrictive sense.

1. A system comprising:
a real-time routing server to route and process multimedia communication sessions over a network;
a group server to manage the multimedia communication sessions over the network, wherein the group server is coupled to the routing server;
a plurality of end-point processing devices to schedule and conduct multimedia communication sessions over the network, wherein the plurality of end-point processing devices are coupled to the routing server and the group server.

2. The system of claim 1, wherein the network is an Internet Protocol (IP) network, wherein each of the routing server, the group server, and the plurality of end-point processing devices has a separate IP address for identification.

3. The system of claim 1, wherein the real-time routing server includes dynamic route processing circuitry to dynamically determine a shortest delay path.

4. The system of claim 1, wherein the real-time routing server in a transit mode can pass through a multimedia communication session without processing data of the multimedia communication session.

5. The system of claim 1, wherein an end-point processing device of the plurality of end-point processing devices comprises a personal computer operated by a user.

6. The system of claim 1, wherein an end-point processing device of the plurality of end-point processing devices comprises a dedicated hardware device.

7. A method for determining a topology of a network, comprising:
obtaining from a group server respective addresses for real-time routing servers to route and process multimedia communication sessions over the network;
setting a static neighbor configuration;
determining a dynamic neighbor configuration based on quality of service levels for respective paths between real-time routing servers, hop counts along paths, delays between real-time routing servers, bandwidth capacity between real-time routing servers, and common path traffic between real-time routing servers.

8. The method of claim 7, further comprising forming a routing table based on neighbor information.

9. The method of claim 7, wherein determining the dynamic neighbor configuration is further based on a network administration policy.

10. The method of claim 7, wherein the operation of determining a dynamic neighbor configuration is repeated when a new real-time routing server is added to the network.

11. The method of claim 7, wherein determining the dynamic neighbor configuration comprises:
obtaining information regarding quality of service levels for respective paths between real-time routing servers, hop counts along paths, delays between real-time routing servers, bandwidth capacity between real-time routing servers, and common path traffic between real-time routing servers;
rejecting all paths not meeting a quality of service requirement;
sorting candidate real-time routing servers according to distance measurements, including hop counts along paths;
determining whether there is path between a first real-time routing server and a candidate real-time routing server;
determining whether a delay between the first real-time routing server and the candidate real-time routing server is less than a maximum delay;
determining whether a bandwidth capacity between the first real-time routing server and the candidate real-time routing server is greater than a minimum bandwidth capacity;
determining whether the candidate real-time routing server shares a common path with neighbor real-time routing server.

12. The method of claim 11, wherein the operations of determining whether there is a path, whether a delay is less than a maximum delay, whether a bandwidth capacity is greater than a minimum bandwidth capacity, and whether a common path is shared are repeated for each candidate real-time routing server.

13. The method of claim 7, wherein the network is an Internet Protocol (IP) network.

14. A method for reserving bandwidth and media processing resources, comprising:
checking whether media processing resources on a source real-time routing server are sufficient for a user to join a multimedia communication session;
for a multimedia communication session involving multiple real-time routing servers, sending reservation requests from the source real-time routing server to all destination real-time routing servers;
checking for notifications of successful bandwidth reservations for paths from the source real-time routing server to destination real-time routing servers;
checking for notification of successful media processing resource reservations for destination real-time routing servers.

15. The method of claim 14, wherein the source real-time routing server checks for the notifications of successful bandwidth reservations and media processing resources.

16. The method of claim 14, wherein the media processing resources are digital signal processing (DSP) resources.

17. The method of claim 14, wherein if the notifications of successful bandwidth reservations and successful media processing resource reservations are not received with a preset time period, then the notifications are not considered to have been received.

18. A method for reserving bandwidth in a network comprising:
receiving at a first real-time routing server a bandwidth reservation request from an upstream real-time routing server;
determining whether at least one downstream path to a destination real-time routing server has enough bandwidth;
if the first real-time routing server is a transit real-time routing server and not a destination real-time routing server, then forwarding the bandwidth reservation request to a downstream neighbor real-time routing server that has enough bandwidth and leaving a usage count unchanged;
if the first real-time routing server is a destination only real-time routing server or a destination and transit real-time routing server, then reserving bandwidth for a path between the first real-time routing server, and the upstream neighbor real-time routing server;
if the first real-time routing server is not only a transit real-time routing server but also a destination real-time routing server, then forwarding the bandwidth reservation request to a downstream neighbor real-time routing server that has enough bandwidth and incrementing the usage counting by one.

19. The method of claim 18, wherein if a bandwidth reservation request is forwarded to a downstream neighbor real-time routing server, then checking for notification of a successful bandwidth reservation for a path from the first real-time routing server to the downstream neighbor real-time routing server.

20. A method for reserving bandwidth in a network comprising:
receiving at a first real-time routing server a bandwidth reservation request from an upstream real-time routing server;
determining whether at least one downstream path to a destination real-time routing server has enough bandwidth;
selecting an upstream neighbor real-time routing server from upstream neighbor real-time routing servers sending a bandwidth reservation request within a predetermined time period;
if the first real-time routing server is a transit real-time routing server and not a destination real-time routing server, then forwarding the bandwidth reservation request to a downstream neighbor real-time routing server that has enough bandwidth and leaving a usage count unchanged;
if the first real-time routing server is a destination only real-time routing server or a destination and transit real-time routing server, then reserving bandwidth for a path between the first real-time routing server and the selected upstream neighbor real-time routing server;
if the first real-time routing server is not only a transit real-time routing server but also a destination real-time routing server, then forwarding the bandwidth reservation request to a downstream neighbor real-time routing server that has enough bandwidth and incrementing the usage count by one.

21. The method of claim 20, wherein selecting an upstream neighbor real-time routing server from upstream neighbor real-time routing servers comprises:
if only one of the upstream neighbor real-time routing servers sending bandwidth reservation requests within the predetermined time period has a maximum usage count, then selecting that upstream neighbor real-time routing server;
if two or more of the upstream neighbor real-time routing servers sending bandwidth reservation requests within the predetermined time period have the maximum usage count, than selecting an upstream neighbor real-time routing server with an earliest arrival time for the bandwidth reservation request.

22. The method of claim 21, wherein if a bandwidth reservation request is forwarded to a downstream neighbor real-time routing server, then checking for notification of a successful bandwidth reservation for a path from the first real-time routing server to the downstream real-time routing server.
